(19) United States
(12) Patent Application Publication
(10) Pub. No.: US 2013/0242580 A1
(43) Pub. Date: Sep. 19, 2013

(54) METHODS AND SYSTEMS FOR LED LIGHTING

(71) Applicant: TWAYNE DESIGNS LLC, Savage, MN (US)

(72) Inventors: Timothy John STEPHANY, Savage, MN (US); Wayne Rudy TOKKESDAL, Buffalo, MN (US)

(73) Assignee: TWAYNE DESIGNS LLC, Savage, MN (US)

(21) Appl. No.: 13/791,204

(22) Filed: Mar. 8, 2013

Related U.S. Application Data
(60) Provisional application No. 61/608,561, filed on Mar. 8, 2012.

(51) Int. Cl. F21V 21/14

(52) U.S. Cl. CPC F21V 21/14
USPC 362/427

(57) ABSTRACT

Methods and systems for a solid state lighting device are described. In an embodiment, a device includes a solid state directional light assembly that directionally emits less than omni-directional light, a first rotation mechanism, an Edison base to receive the first rotation mechanism and a secondary movement mechanism, positioned in contact with the light assembly and first rotation mechanism to provide directional positioning of the light assembly. The first rotation mechanism allows for rotation of the solid state directional light assembly while maintaining an electrical connection through the Edison base.

### CROSS REFERENCE TO RELATED APPLICATIONS

This application claims the benefit of U.S. provisional application No. 61/608,561 filed on 8 May 2012, and which application is incorporated herein by reference. A claim of priority to all, to the extent appropriate, is made.

### FIELD

The field relates to lighting devices, and more particularly to the solid state lighting, e.g., LED lights.

### BACKGROUND

Lighting has been typically accomplished by filament light bulbs for about the past 100 years, as originally developed by Thomas Edison. Filament light bulbs come in many sizes and use various illumination based on amounts of energy they consume, e.g., 25 Watts, 40 Watts, 60 Watts, 100 Watts and up. The standard light bulb uses a threaded base that screws into a standard Edison base receptacle, which is used to mechanically hold the bulb and provide electrical connectivity to the light bulb. This base and receptacle combination is commonly referred to as the “Edison Bulb”. Screw-in filament bulbs are not thought of as energy efficient as a significant amount of the energy is converted to heat instead of light. The filament bulbs generally emit omni-directional light.

Light emitting diode (LED) is considered an energy efficient successor to filament light bulbs. The extensive existing network of Edison Bulb sockets requires that next generation lighting have an option to retrofit with the older screw-in Edison sockets. Challenges of utilizing LED lighting in such circumstances include heat dissipation, energy management and lack of illumination direction control.

### BRIEF DESCRIPTION OF THE DRAWINGS

FIGS. 1A-B are block diagrams of an lighting device, according to an example embodiment;

FIG. 2 is an elevational view of a light emitting diode lighting device, according to an example embodiment;

FIG. 3 is an LED assembly for the lighting device of FIG. 2, according to an example embodiment;

FIGS. 4A-B is a top view of the LED assembly of FIG. 3, according to an example embodiment;

FIG. 5 is an exploded, partial cross sectional view of the LED assembly, according to an example embodiment;

FIG. 6 is a bottom view of an insert sleeve for the lighting assembly, according to an example embodiment;

FIG. 7 is a top view of a bottom socket for the lighting assembly, according to an example embodiment;

FIG. 8 is an enlarged view of a fitment of the rotating part of the assembly, according to an example embodiment;

FIGS. 9A-B are schematic views of a turning structure of the light assembly, according to an example embodiment;

FIG. 10 is a block diagram of a system in the example form of an electrical system within which a set of instructions for causing the machine to perform any one or more of the methodologies discussed herein, e.g., lighting control, may be executed or stored;

FIG. 11 is an LED assembly for the lighting device of FIG. 2, according to an example embodiment;

FIG. 12 is a top view of the LED assembly of FIG. 11, according to an example embodiment; and

FIG. 13 is flow chart for using the solid state light, according to an example embodiment.

FIGS. 14A-B are top and perspective views of a LED assembly, according to an example embodiment.

FIGS. 15A-B are perspective views of a LED assembly with ball and socket connection, according to an example embodiment.

FIGS. 16A-B are perspective views of a LED assembly with a magnetic connector, according to an example embodiment.

FIGS. 17A-D are perspective views of a magnetic connector, according to an example embodiment.

FIGS. 18A-B are perspective views of a LED assembly with a peg and pin component, according to an example embodiment.

FIGS. 19A-B are perspective views of a LED assembly with slotted sleeve component, according to an example embodiment.

FIGS. 20A-B are perspective views of a LED assembly with a tilt mechanism, according to an example embodiment.

### DETAILED DESCRIPTION

Example methods and systems for lighting devices are described. In the following description, for purposes of explanation, numerous specific details are set forth in order to provide a thorough understanding of example embodiments. It will be evident, however, to one of ordinary skill in the art that embodiments of the invention may be practiced without these specific details.

Embodiments of the present invention utilize a standard ‘Edison’ screw-in light bulb base on which embodiments are attached that support at least one solid state LED, its driving circuit, with the ability to change the direction of the LEDs, in relation to the screw in base, while keeping the electrical connections produced by the screw-in base.

The adjustment can include multiple degrees of freedom, such as purely rotation, in the same plane as the screw-in connection, but can also include a secondary dimensional adjustment which in combination, provides a full 180 spherical degrees of adjustment, or a connection which allows the same degree of adjustment in one embodiment. The first rotational component allows for rotational in a horizontal plane with the base or rotation within the base. The secondary or second movement component or mechanism allows for movement in a plane or on an axis separate from the plane of movement of the first rotation mechanism. The lighter heat sink and increased heat dissipation allow for lower-cost and simpler manufacture.

Embodiments of the present invention provide increased efficiency as LEDs are placed in an orientation for optimal directional lighting. The embodiments may be used in standard ‘Edison’ sockets, but re not limited to the screw-in base as new methods are developed.

Embodiments of the present invention allow for the design of solid state devices which need not conform to the standard shape of the Edison ‘globe’ bulb, as solid state devices do not require a vacuum tube, which is required in filament, fluorescent, Compact Fluorescent Lights (CFL's) or induction lights. LEDs are placed on a panel, either flat or curved in any shape desired, providing decorative functions without a fixture or ‘lamp shade’. The LED panels can be encased and shaded, tinted glass/acrylic used to change the desired lighting effect, so that the device provides both luminous and fixture characteristics in one device.

Embodiments of the present invention also add the benefit of natural heat dissipating effects when the LEDS are spaced further apart, and because the LEDs need not be enclosed within a glass or globe sphere, but may optionally be.

Light bulbs may come in standard 25 Watt, 40 Watt, 60 Watt, 100 Watt, A19 filament (e.g., ‘Edison bulbs’) formats and can produce light in all directions (omni-directional). The light intensity may be equal in all directions. Solid state lights (e.g., light emitting diodes (‘LED’)) save energy but are directional by nature. They produce light in one direction, usually in a narrow illumination angle, which can be less than 90 degrees or less than 60 degrees or less than 45 degrees. Standard Edison light bulb sockets are threaded, and the standard bulb is screwed into the socket until the bulb ‘bottoms out’, thus making electrical connections. The alignment of the bulb when fully seated in the socket is arbitrary as male and female threaded components can be manufactured at any rotation. Moreover, the placement of a lamp or socket at a location will further change the end position of the light when fully seated. Controlling this aspect of manufacturing was not a concern for the application of standard Edison style light bulbs which produced light in all directions (omni-directional).

LED lights are quickly displacing compact fluorescence lights (CFL) as the bulb of choice, in the move towards increasing the efficiency without the use of mercury, found in CFL's. Mercury is an environmental pollutant.

Up until now, LED light design packages have been focused on direction applications, like recessed canned lights (R30) where the uni-directional nature of LEDs was an asset.

One way to produce solid state lights that replace traditional filament bulbs, i.e., to achieve 360 degree illumination, is by placing LEDs in all sides of a cylinder, with a few LEDs placed on top of the cylinder.

Solid state light, especially in the A19 form factor, lack the lumens to directly replace most 60 W or 100 W applications. However, many standard light fixtures are directional in nature and do not benefit from the 360 degree illumination of standard Edison bulbs, like ceiling fixtures.

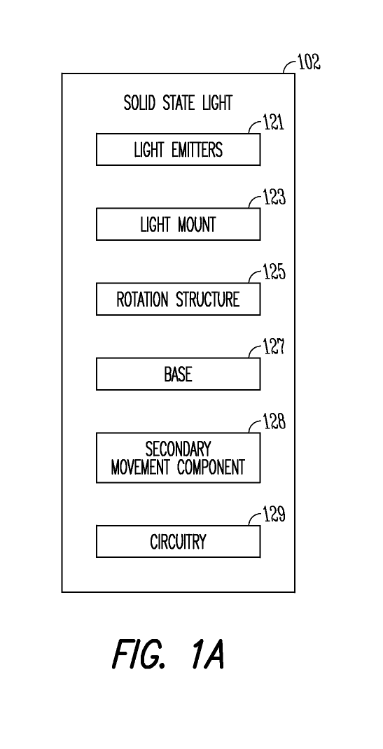

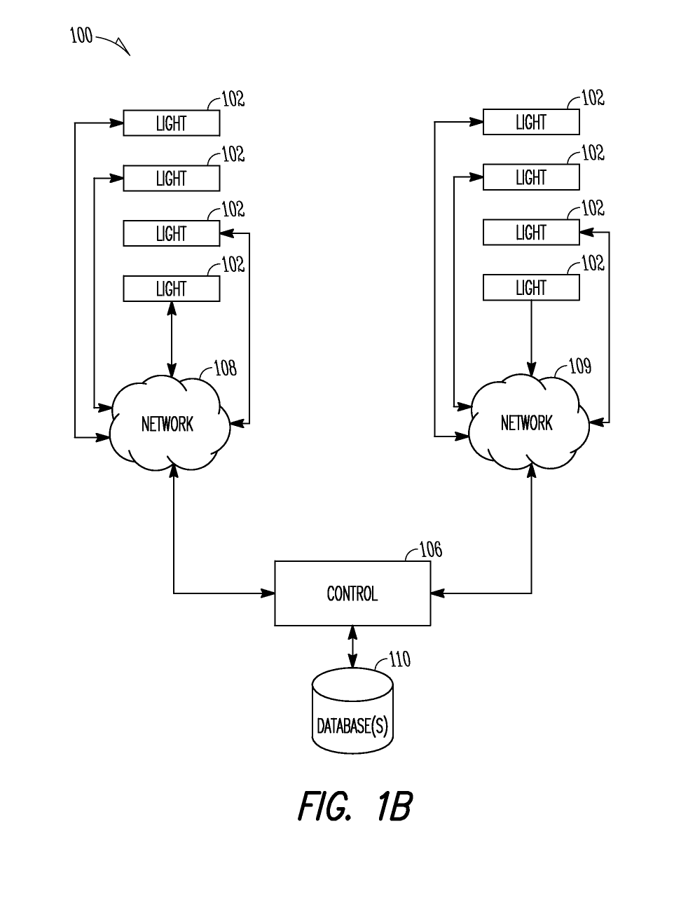

FIG. 1A is a block diagram of an example lighting device 102, according to an example embodiment. The lighting device 102 includes a plurality of light emitters 121. The light emitters 121 are solid state light emitters, e.g., light emitting diodes, or organic light emitting diodes, are set in a light mount 123 to mechanically support the light emitters. The light mount 123 further provides electrical connections to the light emitters. Light mount 123 can be a housing that has a substrate on which the light emitters can be fabricated or mounted to. The light emitters 121 can be hermetically sealed. A base 127 is provided and is connected to the light mount 123 through a rotation structure 125. The base 127 can connected the lighting device 102 to a light location, e.g., a socket. The rotation structure 125 allows the light emitters to be rotated to emit light in a desired direction regardless of the orientation of the base 127 in the light location. The rotation structure 125 allows the light mount 123 to rotate relative to the base 127. In an example, the base 127 is screwed into a threaded socket without concern of its end position. Thus, the light device 102 can be used in any socket regardless of the number of threads, length of threads, or start orientation of the threads with the rotation structure 125 correcting for the orientation of the base 127. The system may include a secondary axis or movement mechanism 128.

Circuitry 129 is electrical circuitry that allows electricity to be delivered to the light emitters 121 regardless of the position of the base 127, rotation structure 125 or the light mount 123. The circuitry 129 may be wiring that delivers household current (in US, 120V, 60 Hz, AC; in European Union, 230 V±6% at 50 Hz, AC.) or other source current. Circuitry 129 can also provide control functions that convert the input current to a signal that can drive the light emitters 121. The drive signal can be less than 5 V, about 3.5 V or less than 3.5 V. The drive signal is typically direct current. The drive signal for the light emitters can be semiconductors with light-emitting junctions designed to use low-voltage, constant current DC power to produce light. LEDs have polarity and, therefore, current only flows in one direction. Circuitry 129 can also dim the light emitters by lowering the current or using Pulsed Width Modulation (PWM) to control the light being output. LEDs have a very quick response time (˜20 nanoseconds) and instantaneously reach full light output. Therefore, many of the undesirable effects resulting from varying current levels, such as wavelength shift or forward voltage changes, can be minimized by driving the light emitters 121 at their rated current and rapidly switching that current on and off. This technique, known as PWM, is the best way to achieve stable results for applications that require dimming to less than 40% of rated current. By keeping the current at the rated level and varying the ratio of the pulse “on” time versus the time from pulse to pulse (commonly referred to as the duty cycle), the brightness can be lowered. The human eye cannot detect individual light pulses at a rate greater than 200 cycles per second and averages the light intensity thereby perceiving a lower level of light.

FIG. 1B is a block diagram of an example system 100, according to an example embodiment. The system 100 includes numerous lighting devices 102, herein shown in two groups, which can be at different locations, e.g., different buildings, different rooms, different locations. The different groups of lights 102 are connected to a control 106, which can be a computing machine or other electrical control device, through networks 108, 109. Networks 108, 109 can be global communication networks, local area networks, wireless networks, building networks, etc. The control 106 can communicate with a memory 110 that stores a database, which can store light control instructions. Such instructions can be individual to each light 102 or to groups of lights 102.

The control 106 includes a control that is described in U.S. Pat. No. 7,393,119, which is hereby incorporated by reference for any purpose. However, if U.S. Pat. No. 7,393,119 conflicts with the present disclosure, the present disclosure controls.

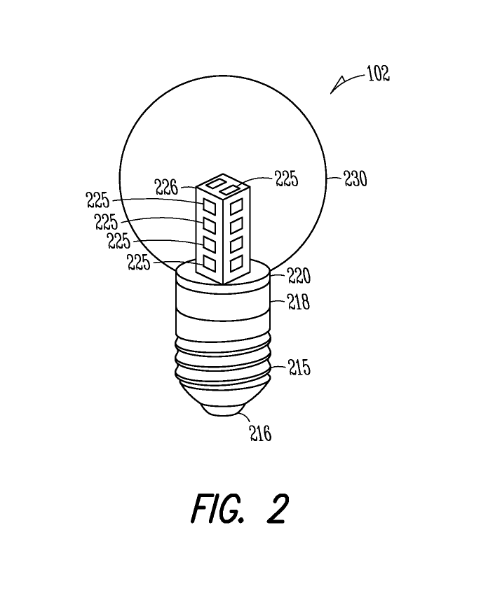

FIG. 2 illustrates the lighting device 102, according to an example embodiment. A base 215 includes outer threads to mate with a threaded socket (not shown) to mechanically mount the lighting device 102 in a lighting system, e.g., a lamp. The base 215 provides electrical connection to energize the lighting the device 102. The outer surface of the base can include at least two electrical contacts. In an example, an electrical contact 216 is provided at the bottom and makes electrical contact when the lighting device 102 is full, securely mounted in a socket. The outer surface of base can act as the other electrode when it is electrically conductive. A coupling 218 is affixed to the top of the base 215. Coupling 218 can include a heat sink. A lighting substrate 220 is on or in the coupling 218 and supports the light emitters 225, which are shown as mounted on a tower 226. Emitters 225 can be LEDs. The base 220 can include circuitry to drive the light emitters 225. A cover 230 is affixed over the tower 226 and seals the light emitters 225 from the environment. The cover 230 can be a globe that is transparent to the light. A globe can be glass or a polymer. The globe may be similar to a conventional globe on an incandescent light bulb. The coupling 218 is rotatable relative to the base 215. The tower 226 is fixed to the coupling and rotates with the coupling relative to the base 215. In an example, the cover 230 and the substrate 220 are also fixed to the coupling 218. In this example, a user can grip the cover, the substrate 220 or the coupling to turn the light emitters 225 relative to the base 215 and the location to which the base 215 is engaged.

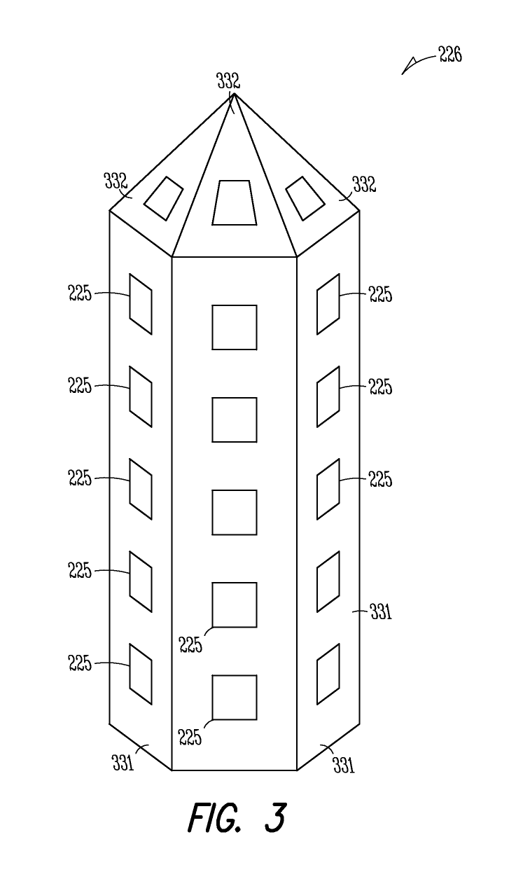

FIG. 3 illustrates the lighting tower 226 that includes a plurality of light emitters 225. The tower 226 can be a polyhedral, e.g., a prism, or a pyramid. The tower can be a triangular prism, a square prism, a pentagon prism, or a hexagonal prism. The tower 226 can be a cylinder. The tower 226 can also be is topped by a hemisphere or a pyramid-type structure. In an example, the light emitters 225 are not mounted to each side, each face, or around the entire circumference of the tower 226. Stated another way, the tower has an area that is free from light emitters. FIG. 3 shows a six-sided prism tower 226 that has light emitters 225 on at least three faces 331 of the tower. A plurality The light emitters 225 are vertically aligned on the three vertical faces 331 shown. At least one of the other faces (not shown in FIG. 3A) does not have light emitters thereon. The top of the tower 226 can also have light emitters on faces 332, e.g., on each face or on a plurality of faces but not all faces.

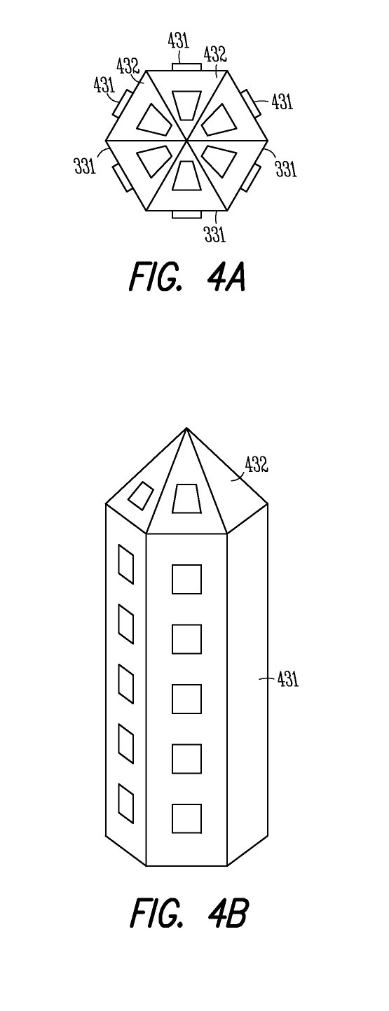

FIGS. 4A and 4B illustrates a top view of a lighting tower 226 and a side view of the lighting tower 226. FIG. 4A shows that at least one face 433 (here shown as half or three of the six vertical faces) of the tower 226 does not have a light emitter. FIG. 4A shows at least one top face 432 (here shown as half or three of the six top faces) of the tower 226 does not have a light emitter. FIG. 4B shows the same tower 226 as shown in FIG. 3 but rotated, e.g., about 60 degrees with the tower 226 being a regular hexagonal prism.

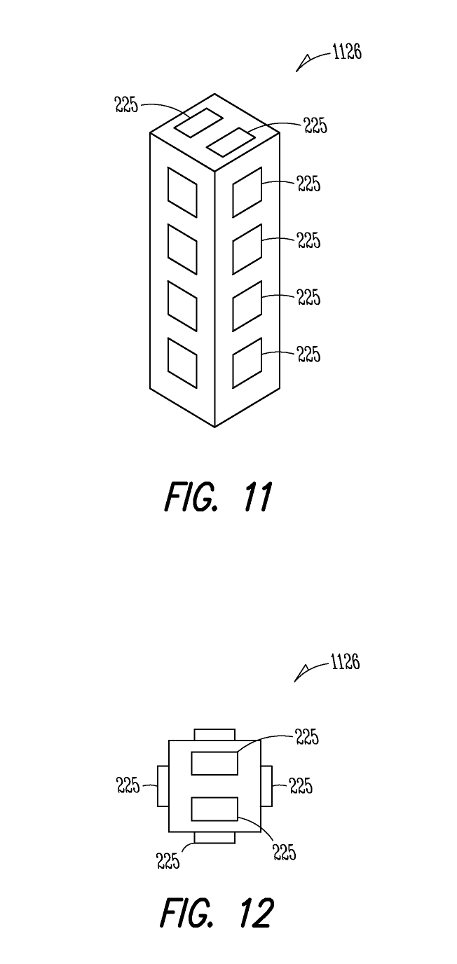

In the example shown and described in FIGS. 3, 4A, and 4B only half of the tower 226 includes light emitters. Accordingly only half of the lighting device emitters light, which emitting faces or surfaces can be oriented in the direction light is needed. It is believed that orienting the light emitters allows the use of half the number of light emitters 225 or a reduced number of light emitters to achieve cost savings in manufacture and in use (e.g., energy savings). Comparing FIGS. 3, 4A, 4B to the example shown in FIGS. 11, 12, the same number of light emitters are used but the light emitters 225 are oriented in direction light is needed. This can increase the usable light or the lumens applied in a useful manner that consumes the same power and same driver as the FIG. 11 or 12 examples.

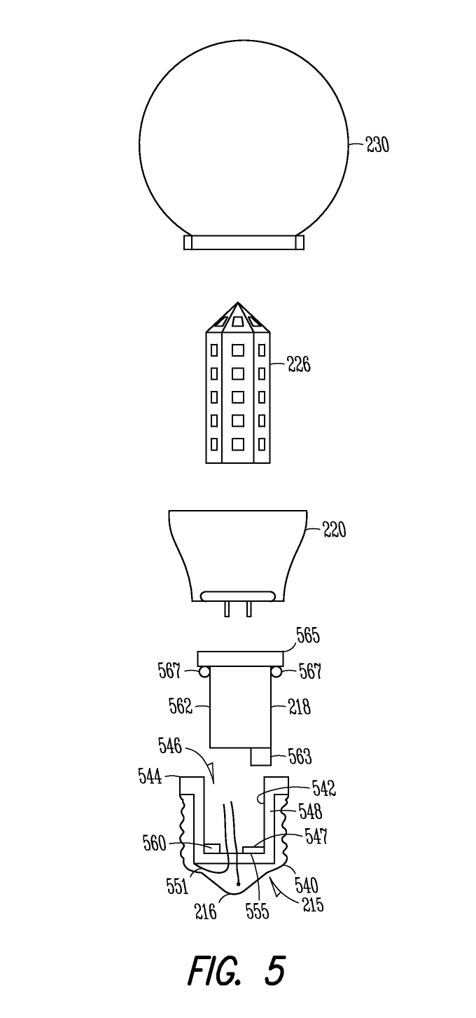

FIG. 5 illustrates an exploded, partial cross sectional view of the lighting device 102. Lighting device 102 can include a base 215, which may, in some example, be referred to as a screw cap. A coupling 218 is rotatably fixed to the base 215. A substrate 220 is fixed to the coupling 218. The light emitter tower 226 is affixed to one of the substrate 220 or the coupling 218.

Base 215 includes a threaded outer shroud 541 that has an outer shape that matches a standard light socket. An upwardly (relative to FIG. 5) recess 542 in which is fixed a sleeve 544. The sleeve 555 has a cup shape with an open top 546 and essentially closed bottom 547 and a cylindrical wall 548 extending between the top and the bottom. The bottom 547 has an aperture 549 through which wires or other electrical conductors 551 extend. A stop 560 is fixed to the bottom 547 of the side wall of the sleeve 555. The stop 560 extends inwardly of the side wall 548 and/or extends upwardly from the bottom 547. The sleeve 555 further extends upwardly above the screw cap 215.

Coupling 218 has a cyclindrical body 562 with an outer diameter that is less than the inner diameter of the sleeve 544. The coupling 218 is rotatable within the sleeve 555. A stop 563 extends downwardly from the bottom of the body 562 and is adapted to contact the stop 560 to stop rotation of the coupling relative to the sleeve 555. The two stops 560, 563 are aligned such that they can selectively contact each other. A rim 565 extends radially outwardly from the top of the main body 562. The rim 565 may define an outer surface of the light device 102. A latch 567 extends outwardly from the main body 56. Latch 567 is sized to engage a channel 868 (FIG. 8) in the sleeve 555. The latch 567 may extend completely around the outer circumference of the main body 562. In an example, a plurality of latches 567 are provided and are spaced from each other around the body 562. The latch 567 does not extend outwardly of the rim 565. Coupling 218 further includes an aperture 569 that aligns with aperture 549 to receive electrical conductors therethrough.

Substrate 220 includes a body that is fixed to the coupling 218 and to which the cover 230 is fixed. The substrate 220 can include the electrical circuitry need to drive the light emitters 102. The substrate 220 can include a heat sink structure to remove heat from the circuitry and from inside the cover 230. Substrate 220 can include fins or other structures to facilitate thermal conductivity.

Light emitter tower 226 is mountable to the substrate 220 for mechanical support. The substrate 220 can also provide electrical signals to the light emitters 102 on the tower 226. The tower 226 can be any tower as described herein.

The cover 230 defines a hollow interior into which the tower 226 extends. The tower 226 does not contact the cover 230. The cover 230 can be a globe. The cover 230 can be made of glass. The cover 230 can be made of a polymer.

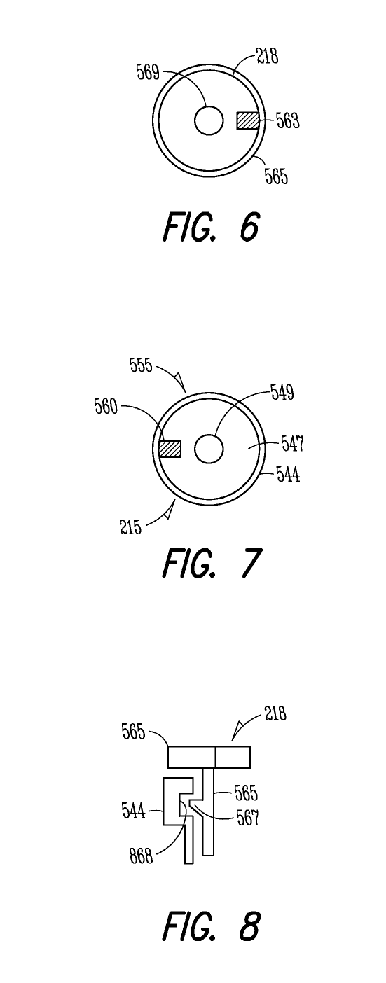

FIG. 6 shows a bottom view of the rotatable coupling 218 of the lighting device 102. The aperture 569 is centrally located on the bottom of the coupling 218. A stop 563 is affixed to the bottom on its bottom side. The stop 563 extends downwardly (relative to FIG. 5) and is in alignment with stop 560 when assembled.

FIG. 7 shows a top view of the base 215 with the stop 560 in the recessed, hollow interior of the base 215. If the base 215 as shown in FIG. 7 is assembly with the coupling as shown in FIG. 6, then the coupling can rotate about 180 degrees before the coupling stop 563 contacts the base stop 560. Once stops 560, 563 contact each other, then the rotational force on the coupling 218 is transferred to the base 215. This allows the user to screw the base 215 into a location, e.g., a threaded socket. Once the base 215 is fixed into its installed location, then the coupling 218 can be rotated almost 360 degrees the other direction (less the width of the stop 560 or less the width of both stops 560, 563) to orient the light emitters on the tower 226. Accordingly, the faces of the tower 226 with a reduced number of light emitters or no light emitters can be located away from the direction in which lighting is desired. The faces of the tower 226 with the lights can be positioned to emit light in the desired direction.

FIG. 8 shows a connection of the coupling 218 to the sleeve 544 using a fitment. In an example, the fitment allows for rotational movement but not longitudinal separation of the coupling 218 from the sleeve 544. The latch 567 includes an included side that allows the wall of the coupling 218 to deform and allow the coupling 218 to move into the sleeve 544. In an example, the latch 567 forces the top part of the sleeve 544 to deflect outwardly and allow the latch to pass. When fully inserted the latch 567 passed a inward lip of the sleeve 544 and is received in the channel 868 below the lip. The latch 567 includes a substantially flat side opposite the incline side that secures the latch in the channel 868. Other snap fits may be used to fix the coupling 218 to the sleeve 544 and/or the base. Such a snap fit can be an annular snap fit. Another example is a ball and socket fitment. Another example is a cantilever snap fit.

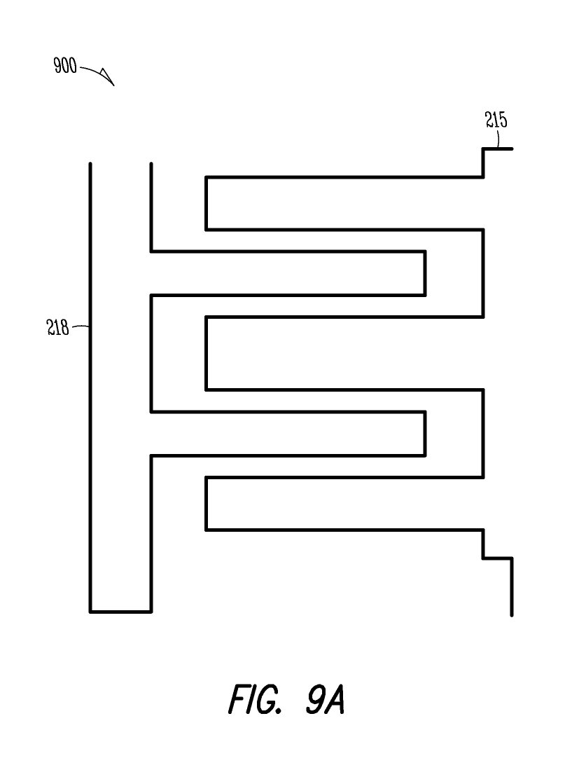

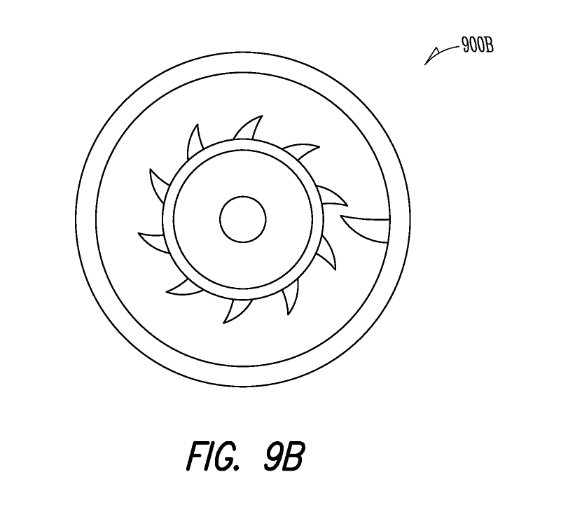

FIG. 9A shows a schematic of a turning mechanism 900 for a lighting device 102. The turning mechanism 900 includes a first plurality of teeth extending rightwardly in FIG. 9a on the coupling 218 and a second plurality of teeth extending leftwardly in FIG. on the base 215. The teeth are interlaced such that the coupling 218 is freely rotatable in the clockwise direction relative to the base 215, until such time as the interlocking teeth (threads) can no longer be turned relative to the base. A stop may be provided and would be engaged during the clockwise rotation of the coupling 218 relative to the base 215 so that the coupling cannot be removed from the base 215 when turned in the opposite direction (counter clockwise) when unscrewing the bulb from the socket. The coupling may rotate more than 360 degrees in an example in the clockwise direction, but is limited in the counterclockwise direction by the stop (stop not shown in drawing 9A).

FIG. 9B shows a schematic view of a turning mechanism 900B that includes a base 218 with an outer wall with threads that may engage a socket. The base wall defines a hollow interior space. A pawl is affixed to the base and extends into the interior. In an example, the pawl is affixed to the bottom or the wall of the base. A toothed gear is affixed to the coupling 218. The coupling can turn in one rotational direction relative to the pawl and the base. This is the mounting direction, e.g., clockwise for right hand threads. When the base is being mounted in a socket the force of the pawl is not overcome. However, once the base is fully mounted in the socket, the base stops turning. If a rotational force is applied to the coupling, it may turn by rotating the gear and wither the teeth of the gear being deflecting verses the pawl or the pawl deflecting verses the gear teeth. The coupling can rotate over 360 degrees in this example. When it is time to remove the light from the socket, the coupling and base turn together in the opposite rotational direction as the pawl prevents relative rotation in that direction.

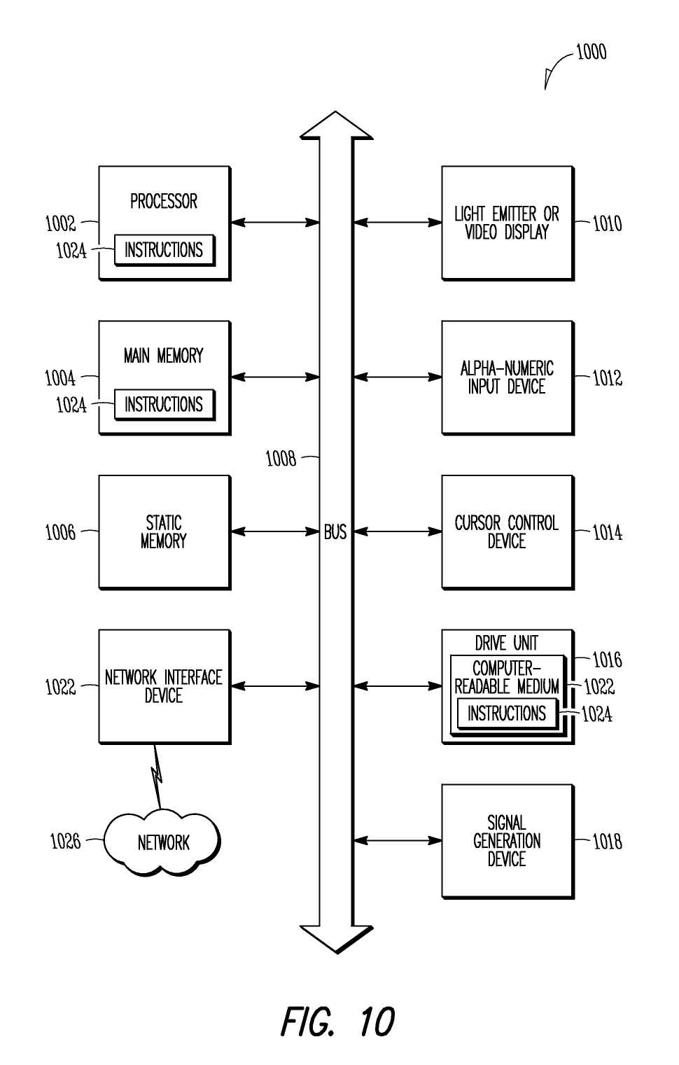

FIG. 10 shows a block diagram of a machine in the example form of a computing system 1000 within which a set of instructions may be executed causing the machine to perform any one or more of the methods, processes, operations, or methodologies discussed herein. The lighting device 102 may include the functionality of the one or more computing systems 1000. One or more computing systems 1000 can control the operation of one or more lighting device 102.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a gaming device, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing system 1000 includes a processor 1002 (e.g., a central processing unit (CPU) a graphics processing unit (GPU) or both), a main memory 1004 and a static memory 1006, which communicate with each other via a bus 1008. The computing system 1000 further includes a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a computer-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computing system 1000, the main memory 1004 and the processor 1002 also constituting computer-readable media.

The software 1024 may further be transmitted or received over a network 1026 via the network interface device 1020.

While the computer-readable medium 1022 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media. In some embodiments, the computer-readable medium is a non-transitory computer-readable medium.

FIG. 11 shows a perspective view of a tower 1126, which may include some of the features of tower 226. Tower 1126 is polyhedral, e.g., a prism. Here shown as four sided. The tower 1126 includes a flat top face that has at least two light emitters 225 thereon. In an example, the light emitters 225 are not mounted to each side, each face, or around the entire circumference of the tower 226. Stated another way, the tower has an area that is free from light emitters. In another example, all of the vertical sides have at least some light emitters thereon. However, some sides may have more light emitters than others. The light emitters 225 are vertically aligned on the two vertical faces shown. At least one of the other faces does not have light emitters thereon, in an example.

FIG. 12 shows a top view of a lighting tower 1126, which is a flat face that is transverse to at least one of the side faces.

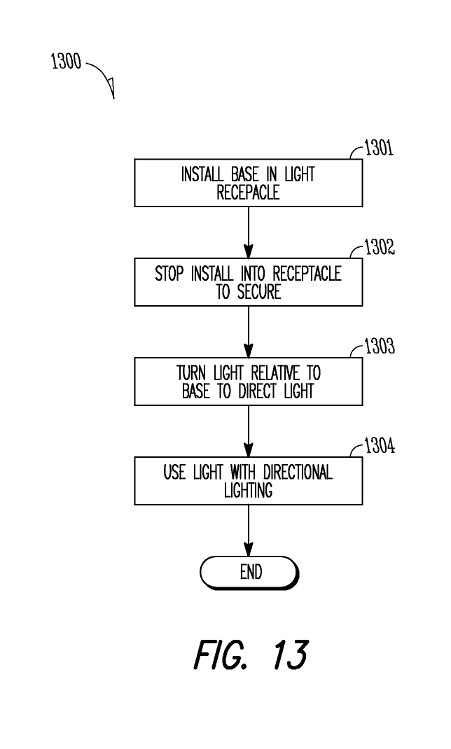

FIG. 13 shows a method 1300 of installing the lights as described herein. At 1301, the base of a light is secured into a socket of a lighting base. The socket is to provide mechanical support and electrical connection to the light, e.g., through the base. At 1302, the install of the base into the socket stops. In an example, the base is fully screwed into an internally threaded socket. At 1303, the light assembly is further rotated relative to the base, which is fixed in place in the socket. At 1304, the light is used, e.g., by the use of control circuitry, which can include switches or other programmable circuits. At the end, the light can be removed when it does not emit light anymore. The light is removed, e.g., by rotating the light relative to the socket in an opposite direction relative to the direction of installation. The light assembly and base rotate together in this direction and not relative to each other. Accordingly, the light assembly and base rotate together. A secondary movement or axis mechanism or component can be positioned or attached between the light assembly and base to provide an additional axis or plane of movement, separate from the first rotation mechanism.

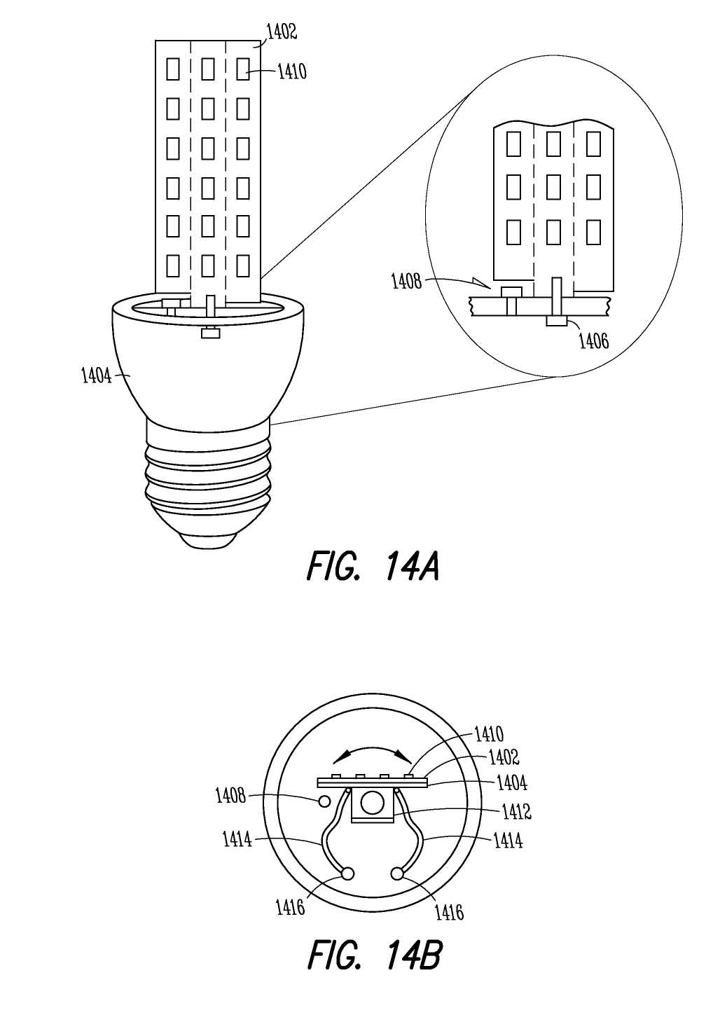

FIGS. 14A-B show a common A19 LED replacement LED design where a rotating LED printed circuit board (PCB) panel 1402 is comprised of heat sink 1404 attached to the LED PCB 1402 on which LEDs 1410 are attached. The PCB heat sink 1404 is attached to a heat sink post 1412. Heat sink post 1412 is attached to heat sink base 1404 via a retention screw 1406, but is not fastened too tightly that will stop rotation, but tight enough to maintain contact with heat sink base 1404. The LEDs may be placed on one flat PCB as shown, or placed on multiple PCBs arranged in such a manner to provide a biased direction of illumination, or the PCB maybe flexible in nature and affixed to a semi-circular substrate. The density and placement of LEDs is such to maximize lumen intensity with heat management disciplines which will not damage nor reduce the useful life of the LED.

Located in the heat sink base 1404 is a rotating stop peg 1408 which includes a head which protrudes above the base. The rotating LED panel 1402 bottom edge has a different clearance between the bottom of one side of the PCB panel and the opposite side. The smaller clearance side of the PCB panel 1402, will contact rotating stop peg 1408 when rotated. When the PCB panel is rotated 350 degrees, the PCB panel 1402 will once again come in contact with rotation stop pin 1408, limiting rotation to less than 360 degrees. This first degree of freedom allows horizontal rotation in respect to the Edison base. The stop pin or peg 1408 allows for horizontal rotation without releasing the LED panel 1402 from the Edison base or screw-in socket. The retention screw 1406 is an example and can be any mechanism that allows rotation of the LED panel 1402 in a horizontal plane, such as a post, column, etc.

Conductor leads or wires 1414 from the LED driver (not shown) to the PCB panel 1402 are placed through holes in the heat sink base 1416. Conducting wires 1414 are long enough to provide full rotation between fully clockwise and counterclockwise rotations of the rotating LED panel 1402.

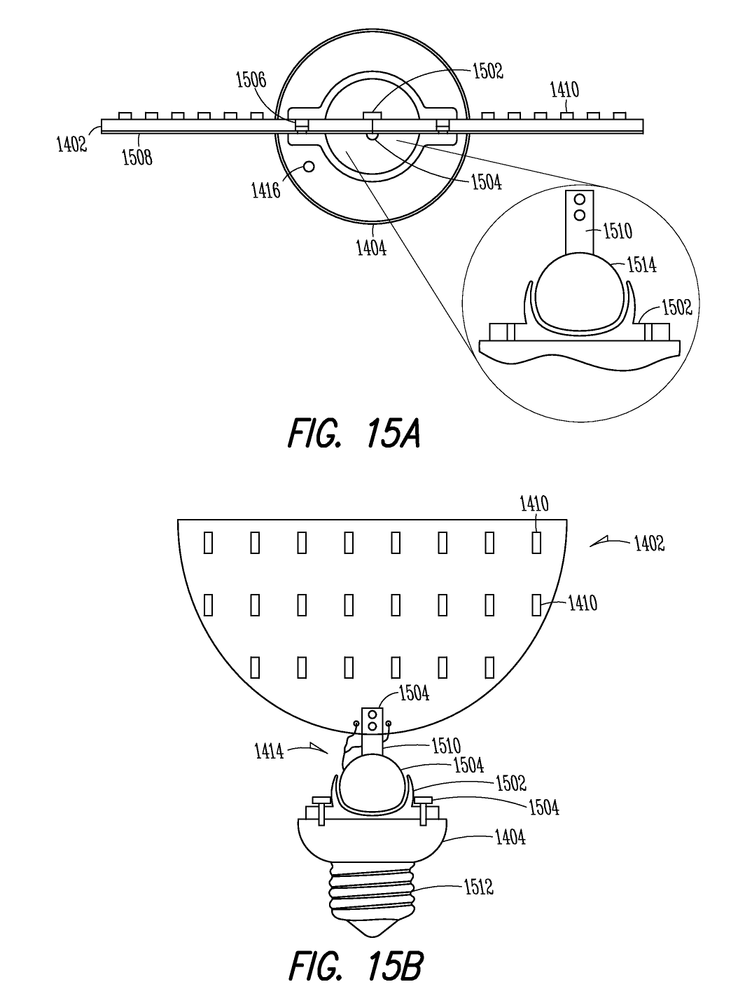

FIGS. 15A-B show a common A19 LED replacement LED design where a directional LED PCB panel 1402 is comprised of LED panel heat sink (optional) 1508 attached to or integrated with the LED PCB 1402 on which LEDs 1410 are attached or integrated.

The mechanism shown for adjustment is an encapsulated ball and socket 1501, comprised of a ball 1514 held by a socket 1502. The force needed to move the ball 1514 within the socket 1502 is such that it supports the directional LED panel 1402 and remains in its position set, but with minimal force can be adjusted to the desired angle.

The directional LED panel 1402 is attached to or integrated with the ball and socket attachment arm 1510 with fasteners 1504. Fasteners 1504 can be any mechanism that joins or holds the components in proximity, including adhesives. The ball and socket 1501 is mounted to the heat sink base 1404 with mounting screws 1516. The ball and socket mechanism can be optionally integrated into the heat sink base 1404, for example. The heat sink base 1404 can contain LED drivers inside of it.

When viewing from a frontal position, the directional LED panel 1402 can be adjusted about 210 degrees front to back, and about 360 degrees of rotation, or any combination of the above. Electric power can be supplied to the directional LED panel 1402 via conductor wires 1414 which are long enough to provide full adjustment front to back and 360 degrees of rotation.

The directional LED panel 1402 may include a rigid PCB panel 1402, or it may be semi flexible to give a concave or convex curve for decorative functions. The shape of the panel 1402 can also impart directional lamination. The directional LED panel 1402 may also be encased within protective envelope to provide electrical insulation protection from electrical shock as well as tinted materials on the LED side to provide color tint adjustment.

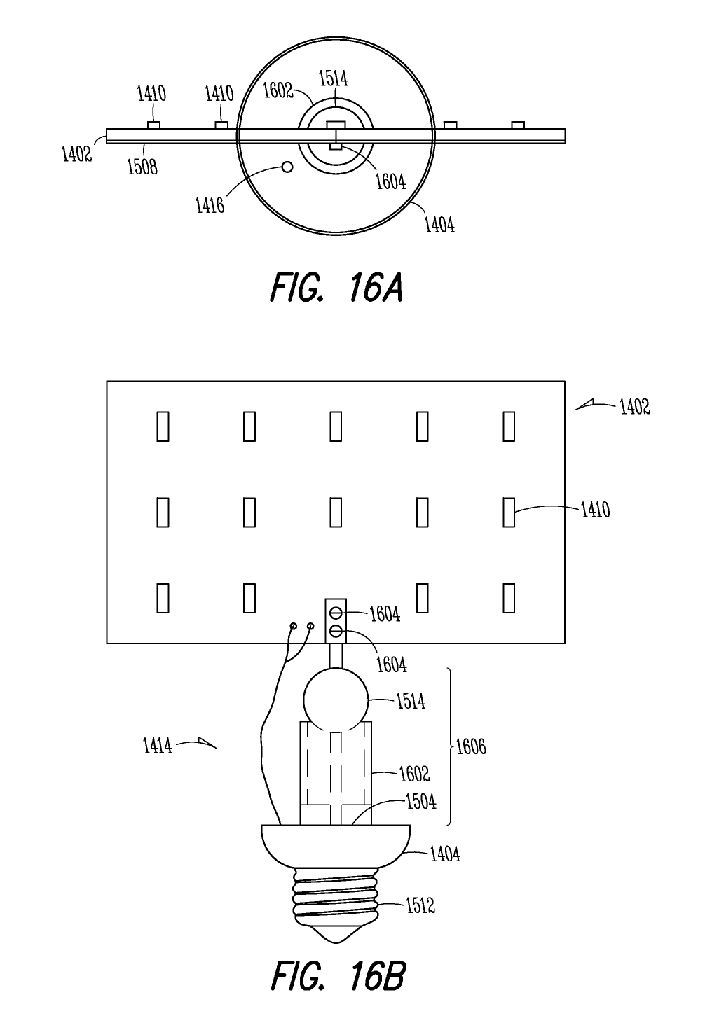

FIGS. 16A-B show a common A19 LED replacement LED design where a directional LED PCB panel 1402 is comprised of LED panel heat sink (optional) 1508 attached to the LED PCB 1402 on which LEDs 1410 are attached.

The mechanism shown for adjustment is a magnetic ball and socket 1606, comprised of a ball 1514 held in a socket by a magnet base 1602. The force needed to move the ball 1514 within the socket 1602 is such that it supports the directional LED panel 1402 and remains in its position set, but with minimal force can be adjusted to the desired angle.

The directional LED panel 1402 is attached to magnetic ball and socket attachment arm 1608 with fasteners 1604. The fasteners can be optional 1604 if the panel is integrated with the arm. The magnetic ball and socket 1606 is mounted to the heat sink base 1404 with mounting screws 1516, or optionally integrated. The heat sink base 1404 can contain LED drivers inside of it.

When viewing from a frontal position, the directional LED panel 1402 can be adjusted about 200 degrees front to back, and about 360 degrees of rotation, or any combination of the above. This provides first and second degrees of rotation and direction for positioning and illumination. Electric power is supplied to the directional LED panel 1402 via conductor wires 1414 which are long enough to provide full adjustment front to back and 360 degrees of rotation. Alternatively, since the magnetic ball joint 1606 is electrically conductive, one conductor wire 1414 may be eliminated when the magnetic base is used as a conductor. For example, two conductive wires or one conductive wire and the magnetic component may be used for electrical connectivity.

The directional LED panel 1402 may include a rigid PCB panel 1402, or it may be semi flexible to give a concave or convex curve for decorative functions. The directional LED panel 1402 may also be encased within protective envelope to provide electrical insulation protection from electrical shock as well as tinted materials on the LED side to provide color tint adjustment.

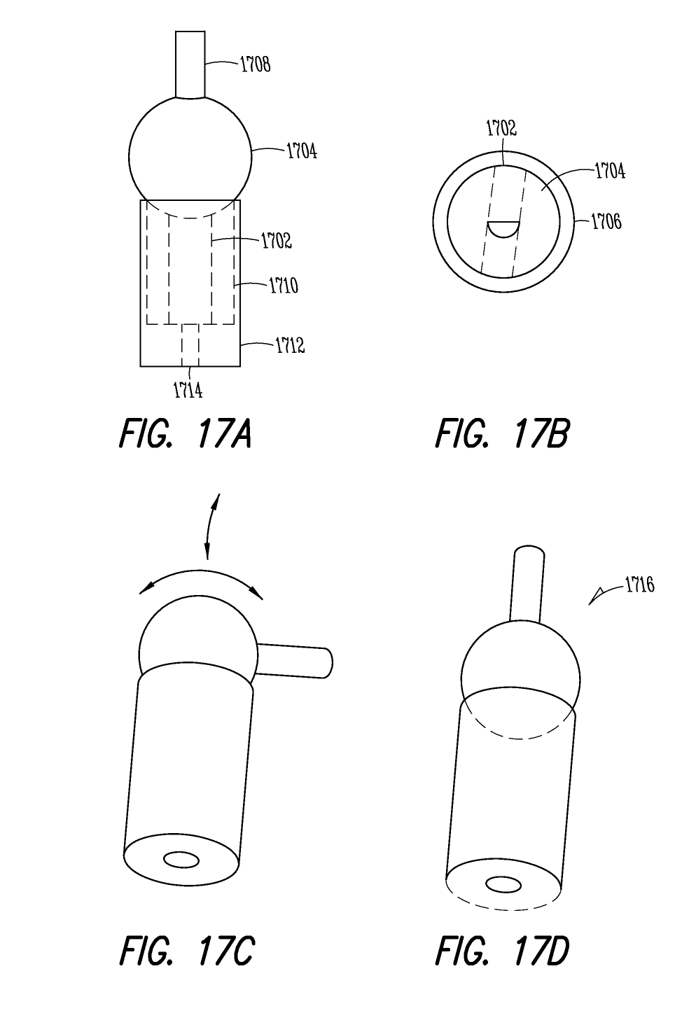

FIGS. 17A-D show perspective views of a magnetic ball and socket attachment mechanism. A steel ball 1704 is in contact with a casing 1706, such as a brass casing. A magnet 1702 is in contact with the ball 1704. An attachment arm 1708 is integrated with or attached to the ball 1704, for attachment to an LED panel 1402. A mounting mechanism 1714, such as a threaded hole is shown on a lower portion of the casing 1712.

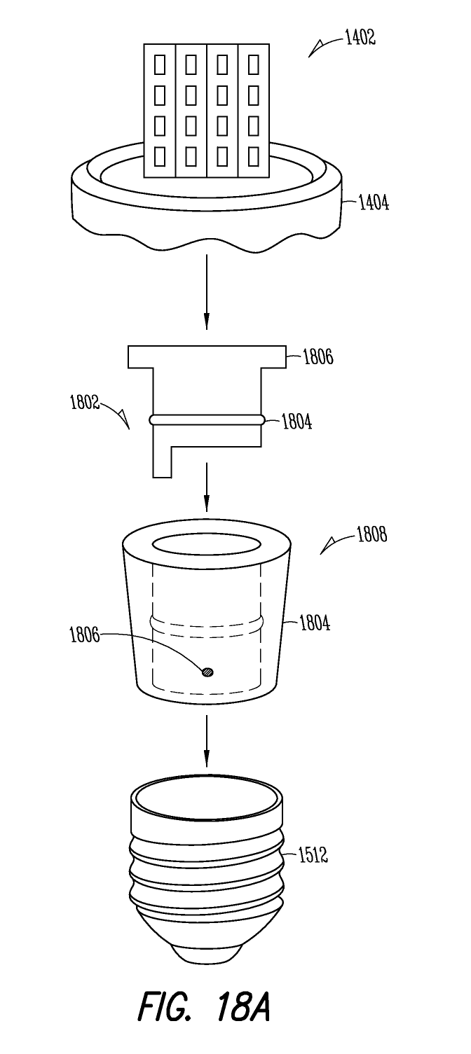

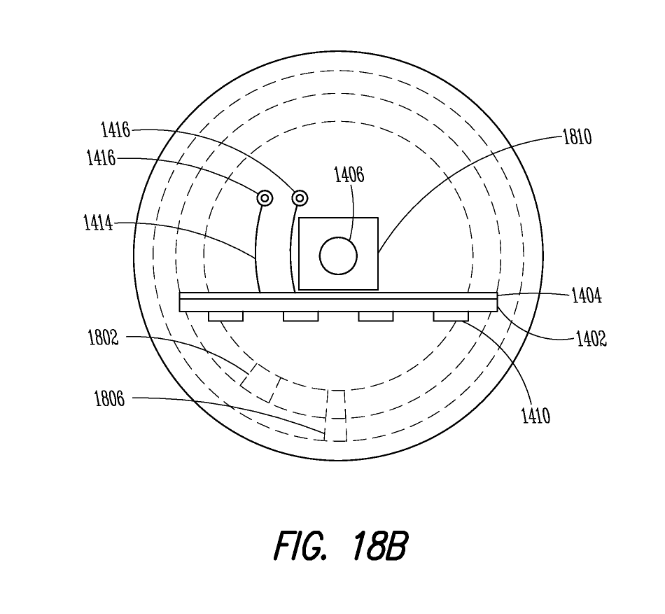

FIGS. 18A-B show a common A19 LED replacement LED design where a rotating coupling mechanism 1806, 1808 allows a LED panel 1402 to be rotated to the desire angle of rotation, after the light bulb has been secured into a standard Edison light socket.

The outer sleeve 1808 is fixed into a standard Edison base either by mechanical or epoxy means. The inner sleeve 1806 is inserted into the outer sleeve. The inner sleeve 1806 is held within the outer sleeve 1808 by a retaining ring 1804, which when inserted, is seated in the optional retaining ring slot 1810, located inside the outer sleeve 1808. The inner and outer sleeves may also be joined by friction, adhesive, mechanical means or another mechanism to join or hold them in proximity. The outer and inner sleeves can be interlocked in which they are joined or positioned in adjacent proximity. The outer sleeve 1808 contacts and holds the light assembly and inner sleeve 1806 to the base, while allowing the inner sleeve 1806 to rotate. The inner sleeve 1806 can have any number of stopping pegs, pins, snaps, etc. that allow it to lock to, affix or hold its alignment with the outer sleeve 1808 and can also act as a point of stopping rotation. The outer sleeve 1808 can include any number of stopping mechanisms, to interact with the peg, pin, snap, etc. on the inner sleeve 1806. A single outer sleeve or inner sleeve could also be utilized with a spring contact. The spring contact including electrical connectivity.

The outer sleeve 1808 has a stopping pin 1802 located so that it protrudes inwards to a depth equal to or slightly less than the thickness of the inner sleeve 1806. The pin is further located so that it only will contact the sides of the stopping cog 1812 feature located on the bottom of the inner sleeve 1806. The inner sleeve 1806 is allowed to rotate freely in one direction until the stopping cog 1812 comes in contact with the stopping pin 1802. Conversely, the inner sleeve 1806 is allowed to fully rotate within the outer sleeve 1808 in the opposite direction, until the point which the stopping cog 1812 contacts with the stopping pin 1802 from the opposite side (direction).

The LED PCB panel 1402 can include a heat sink (optional) 1404 attached to or integrated with the LED PCB 1402 on which LEDs 1410 are attached. The PCB heat sink (optional) 1404 is attached to a heat sink support post 1814, which may also act like as an additional heat sink. Heat sink support post 1814 is attached to heat sink base 1404 via a retention screw 1406 and thermally conductive adhesive (as one option). The retention screw 1406 is fastened tightly to the heat sink base 1404, thus fixing the location LED panel 1402 to the heat sink base 1404. The heat sink base 1404 may contain LED driver circuitry. The heat sink base 1404 is attached to and is supported by the inner sleeve 1806.

Conductor leads 1416 from the LED driver (not shown) to the PCB panel are placed through holes in the heat sink base 1416. Conducting wires 1416 are long enough to provide full rotation between fully clockwise and counterclockwise rotations of the rotating LED panel 1402.

The device is inserted into a standard Edison light socket base and screwed in until good mechanical and electrical contacts are made. At this point, the device may be rotated in the opposite rotation used to insert the bulb, so that the LED panel 1402 is aimed in the desired angle for illumination.

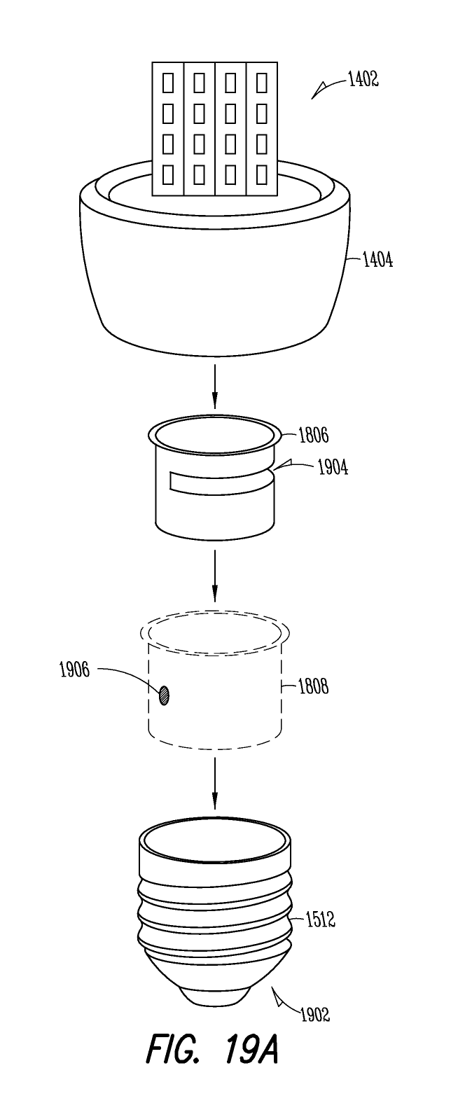

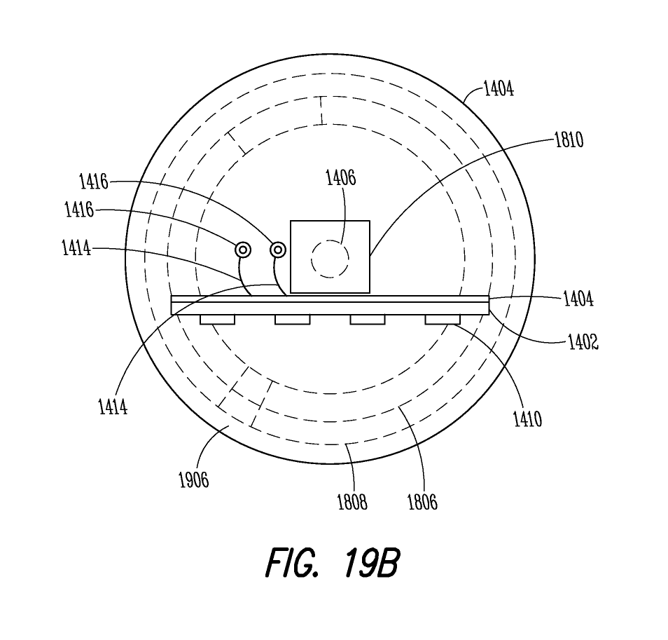

FIGS. 19A-B show a common A19 LED replacement LED design where a rotating coupling mechanism 1806, 1808 allows a LED panel to be rotated to the desire angle of rotation, after the light bulb has been secured into a standard Edison light socket.

The outer sleeve 1808 is fixed into a standard Edison base either by mechanical or epoxy means. The inner sleeve 1806 is inserted into the outer sleeve. The inner sleeve 1806 is held within the outer sleeve 1808 by an optional retaining ring 1810 (not shown), which when inserted, is seated in the retaining ring slot 1904, located inside the outer sleeve 1808. The inner and outer sleeve can be positioned as described previously, as an alternative option.

The outer sleeve 1808 has a stopping pin 1906 located so that it protrudes inwards to a depth equal to or slightly less than the thickness of the inner sleeve 1806. The pin is further located so that it only will contact the sides of the stopping cog 1802 (not shown) feature located on the bottom of the inner sleeve 1806. The inner sleeve 1806 is allowed to rotate freely in one direction until the stopping cog (or stop) 1802 comes in contact with the stopping pin 1906. Conversely, the inner sleeve 1806 is allowed to fully rotate within the outer sleeve 1808 in the opposite direction, until the point which the stopping cog 1802 contacts with the stopping pin 1906 from the opposite side (direction). The inner sleeve 1806 allows movement of the stopping pin through a slot 1904, for example.

The slotted sleeves can include an outer sleeve with stopping pin, an inner sleeve with a slot for movement of the stopping pin, an optional retaining ring for securing the inner and outer sleeves. When the inner sleeve rotates within the outer sleeve the rotation is stopped when the stopping pin comes in contact with the outer edges of the slot. The stopping pin may also act to interlock the two sleeves.

The slotted sleeves can also include an inner sleeve with a flexible locking mechanism, which when inserted into the outer sleeve extends through and past the bottom edge of the outer sleeve, interlocking the two sleeves, but allows them to rotate. The outer sleeve also has extension feature, which stops the rotation of the inner sleeve when the flexible locking mechanism contacts it.

The LED PCB panel 1402 is comprised of heat sink (optional) 1404 attached to the LED PCB 1402 on which LEDs 1410 are attached. The PCB heat sink (optional) 1404 is attached to or integrated with a heat sink support post 1814, which may also act like as an additional heat sink. Heat sink support post 1814 is attached to heat sink base 1404 via a retention screw 1406 and thermally conductive adhesive. The retention screw 1406 is fastened tightly to the heat sink base 1404, thus fixing the location LED panel 1402 to the heat sink base 1404. The heat sink base 1404 may contain LED driver circuitry. The heat sink base 1404 is attached to and is supported by the inner sleeve 1806.

Conductor leads 1414 from the LED driver (not shown) to the PCB panel are placed through holes in the heat sink base 1416. Conducting wires 1414 are long enough to provide full rotation between fully clockwise and counterclockwise rotations of the rotating LED panel 100.

The device is inserted into a standard Edison light socket base and screwed in until good mechanical and electrical contacts are made. At this point, the device may be rotated in the opposite rotation used to insert the bulb, so that the LED panel 100 is aimed in the desired angle for illumination.

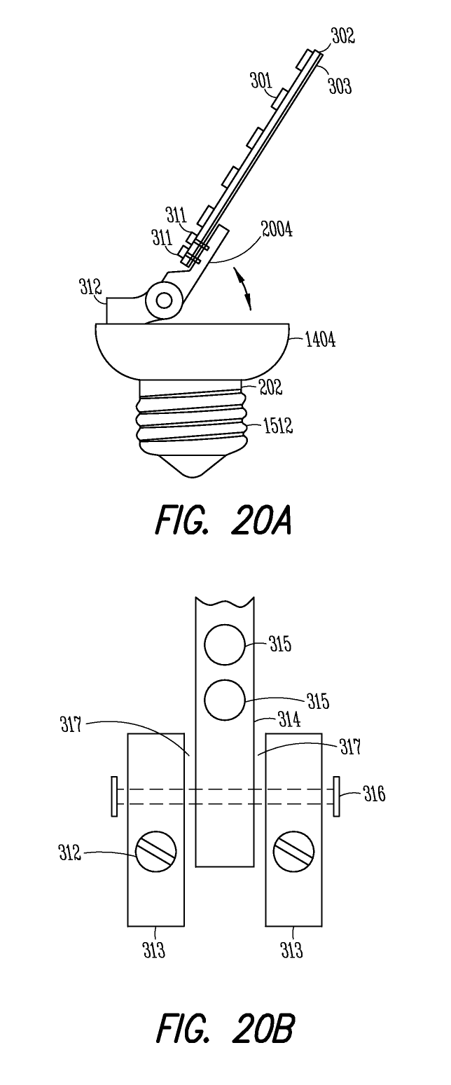

FIGS. 20A-B show a common A19 LED replacement LED design where the heat sink LED drivers 1404 is supported by a rotatable Edison Base 1512. The LED Panel is connected to or integrated with a tilt arm adjustment mechanism 2004. The tilt arm adjustment mechanism allows the LED panel 1402 directional adjustment in a plane which is perpendicular to that of the rotatable base 2002.

The tilt arm adjustment mechanism 2004, is fastened to the heat sink base 1404 by fasteners 2312, through holes in the two fixed arms 2313. The mechanism 2004 can be optionally integrated with the heat sink base 1404 or adhered to the base. The LED panel 1402 is fastened to or integrated with the tilt arm 214 with fasteners 2311 inserted into tilt arm holes 2315. Fasteners can optionally be adhesives.

The tilt arm 2314 is allowed to rotate (tilt) relative to the heat sink base 1404. The tilt arm 2314 is held in between the two fixed arms 2313 with a pivot pin 2316. The holding force of the tilt arm 2314 is such that it will support the LED Panel 1402 in any position. The contact surfaces 2317 may include spring washers (not shown) or matching indexed gears.

The methods, systems and devices described herein can optimize solid state lights, e.g., light emitting diodes, which can be used in the standard filament (e.g., Edison) light sockets. To provide a solution for solid state light, e.g., LED, manufacturers to take full advantage of the directional nature of LED's in the development of bulbs using standard receptacles, e.g., filament light receptacles, Edison screw-in light bulb sockets, blade connections, or the like, while correcting its rotational position that it achieves when fully mounted a socket.

The present disclosure allows the rotation of a light bulb to a position where at it is fully screwed into and seated in a standard socket. The ability to rotate the light emitting section of a light bulb, while maintaining the electrical contacts (not unscrewing the socket of the light bulb) will allow solid state light (e.g., LED) manufacturers to design solid state (e.g., LED) bulbs that will maximize solid state (e.g., LED) panel placement to those sides/angles which are usable. In addition, the secondary axis of movement allows for further utilization of a uni-directional LED. For example, the light will be emitted in a desired direction. Accordingly, fewer solid state lights need to be used. Embodiments of the present disclosure may open up new applications which are not yet identified here.

Currently, LED manufacturers need to design globe style LED bulbs with LEDs on all sides or completely around the circumference because they cannot control the ending rotational alignment of the bulb when fully seated in the Edison light socket. Examples of the present disclosure, allow re-positioning of solid state lights (e.g., LEDs) currently on the ‘backside’ of a bulb to viewable sides, the manufacturer will be able to increase the light output (lumens) by a significant amount, e.g., over 25%, over 40% and at least 50%, without any increases to power consumption. The increased usable lumen efficiency will not require changes to its current electrical drivers or increase in the number of solid state emitters (e.g., LEDs) used.

The presently described examples may be particularly advantageous in ceiling fixtures, wall fixtures, horizontal bathroom fixtures, or any other application where the usable light emitting from the bulb is more usable in one direction but not tin another direction.

The present disclosure, in various examples, describes a two part interconnection system used between the standard Edison socket and the electronic drivers/LED panels. The bottom or ‘fixed socket’ is secured inside the Edison base. The LED circuitry/LED panels are secured to the top or ‘rotating insert’, which is then inserted into the fixed socket.

Solid-state lighting is a newer technology than incandescent lighting and fluorescent lighting that has the potential to far exceed the energy efficiencies of incandescent and fluorescent lighting. Solid-state lighting uses light-emitting diodes or “LEDs” for illumination. A first commercial use of LEDs was for inexpensive consumer devices that use illuminated letters and numbers on the device, e.g., clock radio, watch or other clocks. Solid-state may refer to the fact that the light in an LED is emitted from a solid object, block of semiconductor, rather than from a vacuum or gas tube, as in the case of incandescent and fluorescent lighting. There are two types of solid-state light emitters: inorganic light-emitting diodes (usually abbreviated LEDs) or organic light-emitting diodes (usually abbreviated OLEDs).

A semiconductor is a substance whose electrical conductivity can be altered through variations in temperature, applied fields (electrical or magnetic), concentration of impurities (e.g., doping), etc. The most common semiconductor material is silicon, which is used predominantly for electronic applications (where electrical currents and voltages are the main inputs and outputs). For optoelectronic applications (where light is one of the inputs or outputs), other semiconductor materials must be used, including indium gallium phosphide (InGaP), which emits amber and red light, and indium gallium nitride (InGaN), which emits near-UV, blue and green light.

A light emitting diode (LED) is a semiconductor diode that emits light of one or more wavelengths. Different wavelengths represent different colors. A diode is a device through which electrical current can pass in only one direction. The electrical current injects positive and negative charge carriers which recombine to create light. The diode is attached to an electrical circuit and encased in a plastic, epoxy, resin or ceramic housing. The housing usually consists of some sort of covering over the device as well as some means of attaching the LED to a source of electrical current. The housing may incorporate one or many LEDs. An LED is typically <1 mm² in size, or approximately the size of a grain of sand. However, when encased in the housing, the finished product may be several millimeters or more across.

Because the vast majority of LEDs use inorganic semiconductors, the acronym LED normally refers to inorganic-semiconductor-based LEDs. Some LEDs use organic semiconductors (carbon-based small molecules or polymers), and the acronym OLEDs refers to these organic-semiconductor-based LEDs. They are similar to inorganic-semiconductor-based LEDs in that passing an electrical current through an OLED creates an excited state that can then produce light. OLEDs are less expensive than LEDs, in part because they do not need to be crystalline (or “defect free”). Hence, their fabrication processes are more forgiving, and they can even be applied as large-area coatings on curved, flexible surfaces. However, it is likely that OLEDs will be too fragile to sustain high electrical current density, hence their light output per unit area may be limited. For these reasons, OLEDs may target applications compatible with broad-area light sources, while LEDs target applications compatible with small-area (point-like) light sources.

Incandescent lamps (conventional light bulbs) create light by heating a thin filament to a very high temperature. Incandescent lamps have low efficiencies because most (over 90%) of the energy is emitted as invisible infrared light (or heat). A fluorescent lamp produces ultraviolet light when electricity is passed through a mercury vapor, causing the phosphor coating inside the fluorescent tube to glow or fluoresce. There are efficiency losses in generating the ultraviolet light, and in converting the ultraviolet light into visible light. Incandescent lamps typically have short lifetimes (around 1,000 hours) due to the high temperatures of the filaments, while fluorescent lamps have moderate lifetimes (around 10,000 hours) that are limited by the electrodes for the discharge. LEDs, on the other hand, use semiconductors that are more efficient, more rugged, more durable, and can be controlled (for example, dimmed) more easily. Small LEDs have lifetimes up to 100,000 hours.

Light output is commonly measured in lumens, generally, a convolution of the radiated power and the sensitivity of the human eye. A 60-Watt incandescent bulb produces about 850 lumens. The efficiency of lighting (luminous efficacy) is the light output (lumens) produced per unit of input electrical power (Watts)—or lumens/Watt. An incandescent lamp wastes most of its power as heat, with the result that its luminous efficacy is only around 15 lumens/Watt. A fluorescent lamp is much better at roughly 85 lumens/Watt. These lighting technologies are very mature and their luminous efficacies have not improved much in many years. Today's white LEDs, at around 30 lumens/Watt, have luminous efficacies that are already better than those of incandescent lamps. Moreover, it is believed possible to increase the luminous efficacies of LEDs to as high as 150-200 lumens/Watt, with further improvements in the underlying materials and device properties and design. The present design may appear to the end user as providing greater efficiency as the emitted light is directed as desired regardless of orientation of the supporting structure, lamp base or can, and the threads of the socket. The light emitters can be oriented in a desired direction, e.g., after the light device is mounted in the base or can.

Any of the methods or processes described herein can be stored on a non-transitory machine-readable medium in the form of instructions, which when executed by one or more processors, cause the one or more processors to perform the following operations of the method or process.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A lighting device comprising:
a solid state directional light assembly that directionally emits less than omni-directional light;
a first rotation component;
an Edison base to receive the first rotation component; and
a secondary movement component, positioned in contact with the light assembly and first rotation component to provide directional positioning of the light assembly;
wherein the first rotation component allows for rotation of the solid state directional light assembly while maintaining an electrical connection through the Edison base.

2. The device of claim 1, wherein the first rotation component and secondary movement component comprises a single multi-movement component.

3. The device of claim 2, wherein the single multi-movement component comprises one or more of a ball and socket attachment, magnetic ball and socket attachment and hollow knuckle with rotating shaft.

4. The device of claim 1, wherein the solid state directional light assembly includes a plurality of light emitting diodes.

5. The device of claim 1, wherein the first rotation mechanism comprises one or more interlocking sleeves.

6. The device of claim 5, wherein the interlocking sleeves comprise one or more of peg and pin sleeves, slotted sleeves, snap and stop sleeves, spring contact and rotating panel with heat sink.

7. The device of claim 6, wherein the peg and pin sleeves comprises an outer sleeve with stopping pin, an inner sleeve with stopping peg, a retaining ring for securing the inner and outer sleeves; wherein when the inner sleeve rotates within the outer sleeve the rotation is stopped with the stopping peg comes in contact with the stopping pin.

8. The device of claim 6, wherein the rotating panel with heat sink comprises a retention screw in contact with a heat sink and the light assembly, allowing for rotation of the light assembly until contacting a stop peg positioned in the heat sink base.

9. The device of claim 5, wherein the interlocking sleeves comprises an outer sleeve with stopping pin, an inner sleeve with a slot for movement of the stopping pin, a retaining ring for securing the inner and outer sleeves; wherein when the inner sleeve rotates within the outer sleeve the rotation is stopped when the stopping pin comes in contact with the outer edges of the slot.

10. The device of claim 5 wherein the interlocking sleeves comprises an inner sleeve with a flexible locking mechanism, which when inserted into the outer sleeve, extends through and past a bottom edge of the outer sleeve, sufficient to interlock the sleeves while still allowing rotation.

11. The device of claim 1, wherein the second movement component comprises one or more of a tilt arm adjustment mechanism and a slotted cam.

12. The device of claim 4, wherein the plurality of light emitting diodes are mounted on an elongated tower, which has at least one side that is free of the plurality of light emitting diodes.

13. The device of claim 4, wherein the tower has a plurality of sides and more than two sides have light emitting diodes thereon.

14. The device of claim 1, wherein a plurality of light emitters are mounted on a printed circuit board, which has at least one face that has fewer light emitters than another side.

15. The device of claim 1, wherein the secondary movement component comprises a mechanism for moving the light assembly in a plane different than the first rotation component.

16. The device of claim 1, wherein the secondary movement component comprises a mechanism for moving the light assembly on an axis different than the first rotation component.

17. The device of claim 1, wherein the first rotation component comprises a sleeve and spring contact

18. The device of claim 17, wherein the spring contact allows for electrical connectivity and rotation and the sleeve supports the light assembly and prevents the light assembly from disengaging with the base.

19. A lighting device comprising:
a solid state directional light assembly that directionally emits less than omni-directional light;
a first rotation component, including:
an inner sleeve, including a stopping peg;
an outer sleeve, interlocked with the inner sleeve and including a stopping mechanism that allows rotation of the inner sleeve within the outer sleeve until the stopping peg contacts the stopping mechanism;
an Edison base to receive the first rotation component; and
a secondary movement component, positioned in contact with the light assembly and first rotation component to provide directional positioning of the light assembly on an axis of movement separate than the first rotation component;
wherein the first rotation component allows for rotation of the solid state directional light assembly while maintaining an electrical connection through the Edison base.
